(19) United States
(12) Patent Application Publication
(10) Pub. No.: US 2026/0241575 A1
(43) Pub. Date: Aug. 20, 2026

(54) COMPANION ROBOT, METHOD OF CALCULATING GLOBAL POSITION OF THE SAME, AND USER TERMINAL FOR INTERACTING WITH THE SAME

(71) Applicant: ELECTRONICS AND TELECOMMUNICATIONS RESEARCH INSTITUTE, Daejeon (KR)

(72) Inventors: Seung Min Choi, Daejeon (KR); Beom-Su Seo, Daejeon (KR)

(21) Appl. No.: 19/532,686

(22) Filed: Feb. 6, 2026

(30) Foreign Application Priority Data
Feb. 19, 2025 (KR) 10-2025-0021561
Dec. 10, 2025 (KR) 10-2025-0194830

(51) Int. Cl. B25J 9/16; B25J 19/02; B62D 57/032

(52) U.S. Cl. CPC B25J 9/1697; B25J 19/023; B62D 57/032

(57) ABSTRACT

Provided is a companion robot including: a communication module; a camera module configured to image surroundings; a memory configured to store HD map data of a specified place; and a controller. The controller acquires global position information of a user terminal, which is determined by the user terminal based on an image captured by another camera provided in the user terminal, corresponding to the map data from the user terminal through the communication module, generates a specified pattern image by imaging the user terminal equipped with a specified pattern through the camera module, measures a relative position of the camera module with respect to the user terminal on the basis of feature points of the specified pattern image, and calculates a global position of the companion robot within the map data based on the global position information of the user terminal and the measured relative position.

### CROSS-REFERENCE TO RELATED APPLICATIONS

This application claims priority to and the benefit of Korean Patent Applications No. 10-2025-0021561, filed on February 19, 2025, and No 10-2025-0194830, filed on December 10, 2025, the disclosure of which is incorporated herein by reference in its entirety.

### BACKGROUND

### 1. Field of the Invention

Various exemplary embodiments disclosed in the present document relate to a route guidance technology employing a robot.

### 2. Description of Related Art

Generally, route guidance services are provided on the basis of map data, Global Navigation Satellite System (GNSS) signals, and outdoor movement of inertial sensors. However, GNSS-based route guidance services are difficult to use in GNSS shadow areas.

To address this, service providers build maps of specific areas using their own mapping devices, while users utilize route guidance services through smartphone applications on the basis of positioning resources (e.g., Wi-Fi) that replace GNSS signals. Specifically, maps of public locations such as airports, shopping malls, subways, buildings, etc., are created to provide a route guidance service on the basis of the created map without GNSS signals. For example, smartphone-based route guidance services may be provided on the basis of surrounding positioning resources such as Wi-Fi signals, and detection information of inertial sensors of smartphones.

A technology for creating a map and positioning in a limited area on the basis of images and a three-dimensional (3D) sensor (simultaneous localization and mapping) has lately been disclosed and is being utilized. For example, a guidance robot may autonomously move within a specified place while accompanying a user who has requested its service, providing route guidance and space-related services (e.g., exhibition commentary). Existing guide robots have been built much larger than humans, but they are being implemented in various forms such as guide dog robots these days.

### SUMMARY OF THE INVENTION

Various embodiments disclosed in the present document provide a companion robot for calculating its position more accurately on the basis of a global position of a user terminal when a companion service is provided to a user, and a positioning method of the same.

According to an embodiment disclosed in the present document, there is provided a companion robot including: a communication module; a camera module configured to image surroundings; a memory configured to store HD map data of a specified place; and a controller functionally connected to the camera module and the memory. The controller acquires global position information of a user terminal, which is determined by the user terminal on the basis of an image captured by another camera provided in the user terminal, corresponding to the map data from the user terminal through the communication module, generates a specified pattern image by imaging the user terminal equipped with a specified pattern through the camera module, measures a relative position of the camera module with respect to the user terminal on the basis of feature points of the specified pattern image, and calculates a global position of the companion robot within the map data on the basis of the global position information of the user terminal and the measured relative position.

According to an embodiment disclosed in the present document, there is provided an image-based positioning method of a companion robot including a camera module and storing HD map data of a specified place, the positioning method including: acquiring global position information of a user terminal, which is determined by the user terminal on the basis of an image captured by another camera provided in the user terminal, corresponding to the map data from the user terminal; imaging the user terminal equipped with a specified pattern using the camera module; measuring a relative position of the camera module on the basis of feature points of a specified pattern image corresponding to the specified pattern; and calculating a global position of the companion robot within the map data on the basis of the measured relative position and the global position information.

According to another embodiment disclosed in the present document, there is provided a user terminal for interacting with a companion robot, the user terminal including: a communication module; an output device; a camera configured to image surroundings; a memory configured to store HD map data of a specified place; and a processor functionally connected to the camera and the memory. When a specified application is executed, the processor requests a companion service for arriving at a destination from a companion robot through the communication module, captures a surrounding image using the camera, calculates a global position on the basis of the captured image in accordance with the HD map data, transmits global position information related to the calculated global position to the companion robot, and provides guidance to raise an altitude of the camera through the output device when an altitude based on the global position is less than a reference altitude related to the HD map data.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a set of views illustrating a general method of building a HD map;

FIG. 2 is a view showing an environment in which a companion robot is implemented according to an embodiment;

FIG. 3 is a block diagram of a companion robot and a user terminal according to the embodiment;

FIG. 4 is a diagram illustrating a method of estimating a relative position of a companion robot on the basis of a specified pattern (a general pattern including a checkerboard) according to the embodiment;

FIG. 5 is a set of views showing a change in the awareness of a relative position depending on distance according to the embodiment;

FIG. 6 is a flowchart of a companion guidance service method according to an embodiment; and

FIG. 7 is a flowchart of a global position calculation method according to an embodiment.

In relation to the description of drawings, like reference numerals may be used for like components.

### DETAILED DESCRIPTION OF EXEMPLARY EMBODIMENTS

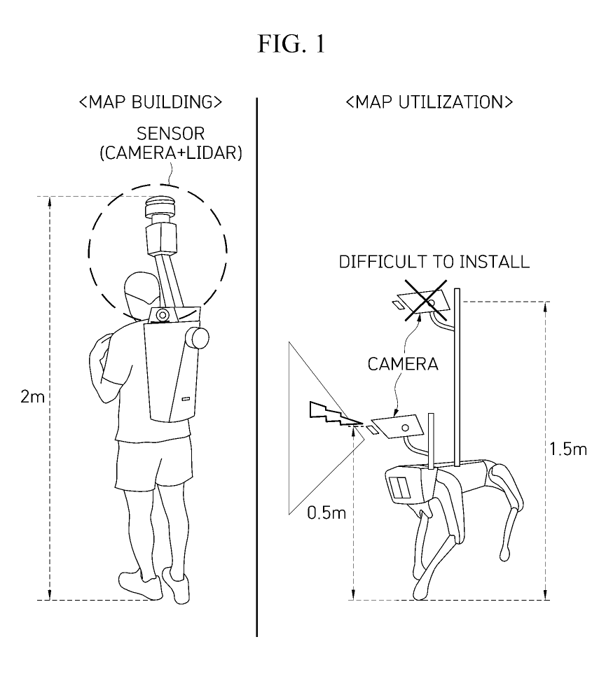

FIG. 1 is a set of views illustrating a general method of building a HD map.

Referring to map building in FIG. 1, while carrying a bag to which sensors (a camera and a lidar) of a map building apparatus kept approximately two meters above the ground are attached, a map builder moves in a specified place and collects environmental data of the specified place by imaging the specified place using the sensors. Subsequently, a service device linked to the map building apparatus may build a HD map of the specified place using the collected environmental data. The sensors of the map building apparatus may be positioned at a first height (about 2 meters) above the ground (hereinafter “reference height,”).

On the other hand, referring to map utilization in FIG. 1, a small or medium-sized robotic system such as guide dog robots has a low height. Therefore, a camera of the small or medium-sized robotic system is positioned at a height of approximately 0.5 meters above the ground (hereinafter “second height”). Therefore, the small or medium-sized robotic system images the environment of the specified place using the camera positioned at the height (e.g., 0.5 meters) lower than that used for building the HD map. This enables the small or medium-sized robotic system to capture images with a different view angle compared to images taken to build the HD map.

Also, the small or medium-sized robotic system shakes while moving, making it difficult to install a camera at the same height as the camera used for building the HD map. For example, a vertical pole may be used to install the camera higher above the small or medium-sized robotic system. However, this installation may cause various problems such as shakes of the camera, degradation of walking stability, increased mechanical complexity, and the like.

As described above, when a height of a recognition camera for map utilization is different from a height of a camera for map building, a difference in view angle may occur during imaging. When this height difference is a threshold distance (e.g., double) or more, a success rate of image-based positioning may be very low.

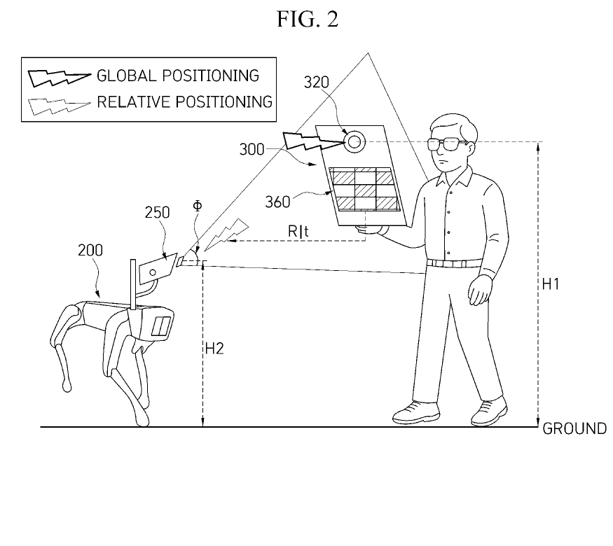

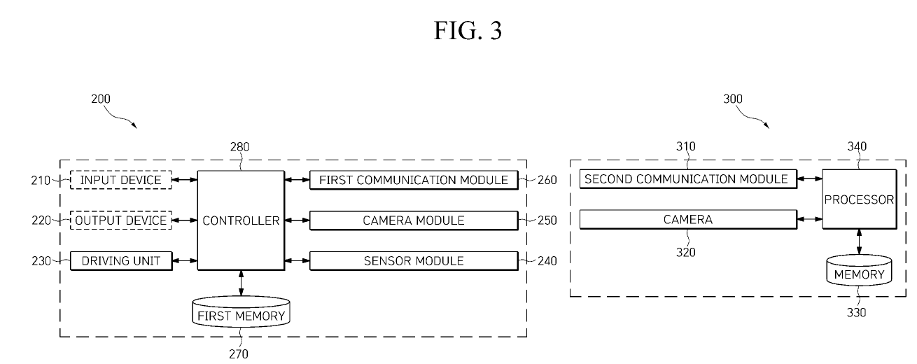

FIG. 2 is a view showing an environment in which a companion robot is implemented according to an embodiment, and FIG. 3 is a block diagram of a companion robot and a user terminal according to the embodiment.

Referring to FIG. 2, a user terminal 300 is a terminal with a specified application (positioning application) for interacting with a companion robot 200. While a companion service is used, a pattern board (checkerboard) 360 including a specified pattern is attached to the back of the user terminal 300. Here, the specified pattern is illustrated as a checkerboard for convenience of description. However, this is merely one example, and any general pattern or marker including at least four three-dimensional (3D) reference feature points may be used.

Referring to FIG. 3, the user terminal 300 may include a second communication module 310, a camera 320, a second memory 330, and a processor 340. The user terminal 300 may further include another input device and another output device.

When there is no user of the companion service, the specified pattern board 360 may be positioned in a docking part of the companion robot 200. The specified pattern board 360 may be separated from the docking part by a user and then attached to the user terminal 300. The positioning application may be an application for a positioning service such as the ARC eye service of Naver corp.

Referring to FIG. 2, the companion robot 200 is a robot that provides the companion service to a user, and may be, for example, a guide dog robot. A height (or altitude) of an origin point (center point) of a camera module 250 may be a height H2 lower than a sensor height used for generating HD map data, for example, half the reference height or less, above the ground (on which the companion robot 200 is located). The user terminal 300 may be used for positioning with an origin point of the camera 320 positioned at a face height H1 of the user.

The companion robot 200 may have a docking part (housing) for the specified pattern board 360 and detect whether the specified pattern board 360 is docked in the docking part. When providing the companion service in accordance with a user request, the companion robot 200 may monitor whether the specified pattern board 360 is attached to the back of the user terminal 300 after separated from the docking part through, for example, the camera module 250 and a sensor module 240. With the specified pattern board 360 attached to the back of the user terminal 300, the companion robot 200 may calculate a global position thereof using a global position of the user terminal 300 and an image of the specified pattern board 360.

Referring to FIG. 3, the companion robot 200 according to the embodiment may include the camera module 250, a first communication module 260, a first memory 270, and a controller 280. According to the embodiment, some components of the companion robot 200 may be omitted, or additional components may be further included. For example, the companion robot 200 may further include a sensor module 240 and a driving unit 230. However, the corresponding components are obviously derivable by those of ordinary skill in the art, and detailed description thereof will be omitted. The companion robot 200 may further include an input device 210 and an output device 220. Some components of the companion robot 200 may be combined into one entity, which may perform the same functions as the corresponding components before the combination. For example, at least some components or functions of the companion robot 200 may be included in a service server (not shown), and the companion robot 200 may perform interact with the service server to perform operations in accordance with the present document.

A configuration of the companion robot 200 will be described with reference to FIGS. 2 and 3, while some operations of the user terminal 300 will also be described.

The input device 210 may receive a user input for using the companion robot 200. The input device 210 may include at least one input defection circuit such as a button, a touchscreen, and a microphone. The user input may include, for example, a request for a route guidance service or destination setting within a specified place.

The output device 220 may visually or auditorily output at least one kind of data among signs, numerals, and characters in accordance with control of the controller 280. The output device 220 may include at least one of, for example, a liquid crystal display (LCD), an organic light-emitting diode (OLED) display, a touchscreen display, and a speaker. The output device 220 may output guidance information to, for example, the user of the companion robot 200 in accordance with control of the controller 280.

The driving unit 230 may control movement (direction changes, speed adjustment, and whether to drive) of the companion robot 200 using an autonomous driving function in accordance with control of the controller 280. Since operations of the driving unit 230 may obviously be derived from general autonomous driving services, detailed description thereof will be omitted.

The sensor module 240 may include an inertial measurement unit (IMU) sensor for detecting movement of the companion robot 200. The sensor module 240 may further include a sensor (hole sensor) for detecting whether a specified pattern is docked. For example, the hole sensor may be provided in the docking part of the specified pattern board 360 and may detect internal magnetic force of the specified pattern board 360 docked in the docking part. When the hole sensor provides the detected magnetic force to the controller 280, the controller 280 may determine whether the specified pattern board 360 is docked on the basis of the provided magnetic force. In this regard, the specified pattern board 360 may have a magnet for generating magnetic force or the like.

The camera module 250 may be a red-green-blue (RGB)-depth (D) camera or may further include a LiDar system. The RGB-D camera may include at least one image sensor among a charge-coupled device (CCD) image sensor and a complementary metal oxide semiconductor (CMOS) image sensor. The camera module 250 may capture and generate surrounding images of the companion robot 200 in accordance with control of the controller 280. The camera module 250 may include at least one camera for capturing surrounding images of the companion robot 200.

The height of the camera module 250 (the height of the origin point of the camera module 250 above the ground) may vary depending on movement of the companion robot 200. However, the height of the camera module 250 may not exceed the reference height in a normal use state. The camera module 250 may be formed with a view angle Φ for imaging the user accompanied by the companion robot 200.

The first communication module 260 and the second communication module 310 may support establishment of a communication channel or a wireless communication channel between the companion robot 200 and the user terminal 300 and communication via the established communication channel. The communication channel may include at least one communication channel among, for example, Wireless Broadband (WiBro), wireless local area network (WLAN), Wi-Fi, Bluetooth, ZigBee, Wi-Fi direct (WFD), ultrawideband (UWB), Infrared Data Association (IrDA), Bluetooth Low Energy (BLE), near field communication (NFC), 3rd Generation (3G), 4th Generation (4G), 5th Generation (5G), and 6th Generation (6G) communication channels.

The first memory 270 and the second memory 330 may include various kinds of volatile memories or non-volatile memories. For example, the first memory 270 and the second memory 330 may include a read-only memory (ROM) and a random access memory (RAM). According to the embodiment, each of the first memory 270 and the second memory 330 may be located inside or outside the controller 280 or the processor 340 or connected to the controller 280 or the processor 340 via various known devices. Each of the first memory 270 and the second memory 330 may store various data used by at least one component (e.g., the controller 280 and the processor 340) of the companion robot 200 and the user terminal 300. The data may include input data or output data of, for example, software or commands related thereto. For example, the first memory 270 may store at least one instruction and data for providing a HD map-based companion service (e.g., route guidance). The first memory 270 may store HD map data of the specified place. The first memory 270 may store internal parameters of the camera module 250 and reference coordinate values of the specified pattern board 360. The reference coordinate values may be 3D coordinate values of the feature points of the specified pattern board 360. Similarly, the second memory 330 may store HD map data and a specified application for HD map-based positioning.

The controller 280 may control at least one other component (e.g., hardware or software component) of the companion robot 200 and perform various kinds of data processing or computations. Similarly, the processor 340 may control at least one other component (e.g., hardware or software component) of the user terminal 300 and perform various kinds of data processing or computations. Each of the controller 280 and the processor 340 may include at least one of a central processing unit (CPU), a graphics processing unit (GPU), a microprocessor, an application processor, an application-specific integrated circuit (ASIC), and a field programmable gate array (FPGA) and may have a plurality of cores.

The controller 280 may provide the companion service (e.g., the route guidance service) in accordance with the user’s request via the input device 210. For example, when the user checks the companion robot 200 in the specified place and inputs a destination that he or she wants to go to via the input device 210, the companion robot 200 may provide the route guidance service for the input destination.

The controller 280 may output necessary guidance to the user via the output device 220 while providing the route guidance service. For example, when the request for the route guidance service is confirmed, the controller 280 may output an audio prompt requesting that the user attach the specified pattern board 360, such as “Please attach the specified pattern to the back of your user terminal,” via the output device 220.

Using at least one sensor among the sensor module 240 and the camera module 250, the controller 280 may determine whether the specified pattern board 360 is separated from the companion robot 200 and attached to the back of the user terminal 300. For example, the controller 280 may determine whether the specified pattern board 360 is separated from the companion robot 200 using at least one sensor among the sensor module 240 and the camera module 250. After the specified pattern board 360 is separated from the companion robot 200, the controller 280 may track the specified pattern board 360 via the camera module 250 to determine whether the specified pattern board 360 is attached to the back of the user terminal 300.

The controller 280 may acquire a global position of the user terminal 300 from the user terminal 300 via the first communication module 260. In this regard, the user terminal 300 may capture images of surroundings through the camera 320 and calculate the global position on the HD map (hereinafter “first position information”) through the specified application on the basis of the captured images. The user terminal 300 may provide the calculated global position to the companion robot 200 via the second communication module 310, and the controller 280 may acquire the global position of the user terminal 300 via the first communication module 260. The user terminal 300 may periodically (e.g., at 5-second intervals) provide global position information to the companion robot 200.

According to the embodiment, the controller 280 may check that the specified pattern board 360 is attached to the back of the user terminal 300 through at least one sensor and then capture a specified pattern image including the specified pattern board 360 and a rear camera 320 of the user terminal 300 through the camera module 250. The controller 280 may calculate a relative position of the companion robot 200 on the basis of the specified pattern image.

According to one embodiment, the controller 280 may detect feature points of the specified pattern included in the specified pattern image and calculate two-dimensional (2D) coordinate values of the detected feature points. When the specified pattern is a checker pattern, the feature points may include a reference corner point (e.g., the upper-left corner point) on the specified pattern image and all corner points of each piece of the checker pattern. The controller 280 may load reference coordinate values of the specified pattern board 360 such as coordinate values of each feature point on the specified pattern board 360, from the first memory 270. The controller 280 may determine a rotation vector and a translation vector of the companion robot 200 on the basis of the correspondences between 2D coordinate values of the detected feature points and 3D reference coordinate values and the internal parameters of the camera module 250. The controller 280 may calculate a relative position of the companion robot 200 on the basis of the determined rotation vector and translation vector.

Meanwhile, a relative position of a reference point of the specified pattern board 360 with respect to the origin point of the camera 320 of the user terminal 300 may be fixed. When it is determined that the specified pattern board 360 is attached to the back of the user terminal 300, the controller 280 may measure the relative position of the reference point on the specified pattern board 360 with respect to the origin point of the camera 320 (hereinafter “first reference relative position”). The companion robot 200 may determine the rotation vector and translation vector (or a relative position) of the companion robot 200 on the basis of not only the first reference relative position but also a relative position (hereinafter “second reference relative position”) of the camera module 250 with respect to a coordinate system of the companion robot 200.

According to the embodiment, the controller 280 may calculate a global position of the companion robot 200 using the acquired global position and relative position (or the rotation vector and the translation vector) of the user terminal 300.

As described above, the controller 280 may calculate a global position of the companion robot 200 using both a global position acquired from the user terminal 300 and a relative position of the companion robot 200 calculated on the basis of a specified pattern.

However, depending on the user’s movement, the specified pattern board 360 may not be imaged by the camera module 250 of the companion robot 200, or an error may occur in global position determination/transmission of the user terminal 300. Then, the controller 280 may fail to perform at least one of acquiring the global position from the user terminal 300 and calculating the relative position of the companion robot 200 on the basis of the specified pattern image.

In this case, the controller 280 may determine whether a warning condition is satisfied. The warning condition may be at least one of, for example, a case where the global position of the user terminal 300 is not acquired, a case where the global position of the companion robot 200 is not calculated one or more times after the companion service is requested, a case where a threshold period (e.g., 10 seconds) has elapsed since the previous time of calculating the global position, a case where the companion robot has moved a threshold distance, and a case where the companion robot has changed its direction a certain number of times or more.

When the warning condition is satisfied, the controller 280 may notify the user of a positioning error via the output device 220. On the other hand, when the warning condition is not satisfied, the controller 280 may calculate a current global position of the companion robot 200 from the previous global position by utilizing odometry and movement of the companion robot 200 detected by the sensor module 240.

When the positioning error occurs due to the specified pattern board 360 not being detected, the controller 280 may output a warning (e.g., warning message) requesting that the specified pattern board 360 be shown. When the controller 280 recognized the specified pattern board 360 again and calculates a relative position on the basis of a specified pattern image, the service may resume.

According to various embodiments, when the global position of the user terminal 300 is acquired, the controller 280 may determine whether a camera height (a height of the origin point of the camera 320) of the user terminal 300 is a threshold height or less. When the camera height of the user terminal 300 is the threshold height or less, the controller 280 may warn the user to hold the user terminal 300 higher via the output device 220. The threshold height may be experimentally determined to correspond to a height at which a success rate of positioning becomes very low due to a difference in view angle. The threshold height may be a height equal to, for example, half the reference height.

According to various embodiments, the specified pattern board 360 may include the camera 320 and the second communication module 310. In this case, the specified pattern board 360 may be used in place of the user terminal 300. In addition, at least one of the input device 210 and the output device 220 may be omitted, and the companion robot 200 may interact with the user terminal 300 via the first communication module 260.

According to various embodiments, the companion robot 200 may be a swarm robot. In this case, when the companion robot 200 is a reference robot, the companion robot 200 may be aware of its global position. On the other hand, when the companion robot 200 is a swarm robot other than a reference robot, the companion robot 200 may only be aware of its relative position with respect to the reference robot to obtain its global position.

According to various embodiment, at least one operation of the companion robot 200 may be performed by the user terminal 300. For example, when the specified application is executed, the processor 340 may request the companion service for arriving at a destination from the companion robot 200 through the second communication module 310. The processor 340 may capture surrounding images using the camera 320 and calculate a global position on the basis of the captured images in accordance with the HD map data. The processor 340 may transmit global position information related to the calculated global position to the companion robot 200. The processor 340 may compare an altitude in accordance with the global position with a reference altitude related to the HD map data and provide guidance to raise an altitude (or height) of the camera 320 via another output device when the altitude in accordance with the global position is less than the reference altitude.

As described above, the camera module 250 of the companion robot 200 according to the embodiment has a different view angle than a camera used for generating the existing HD map data, but the global position of the companion robot 200 can be corrected on the basis of the specified pattern image and the global position of the user terminal 300. Therefore, it is possible to prevent the performance of image-based positioning from being degraded due to a difference in view angle.

In addition, the companion robot 200 according to the embodiment utilizes a previously built HD map for people, vehicles, etc., without generating new map data for a small robot service, thus leading to a reduction in service implementation costs.

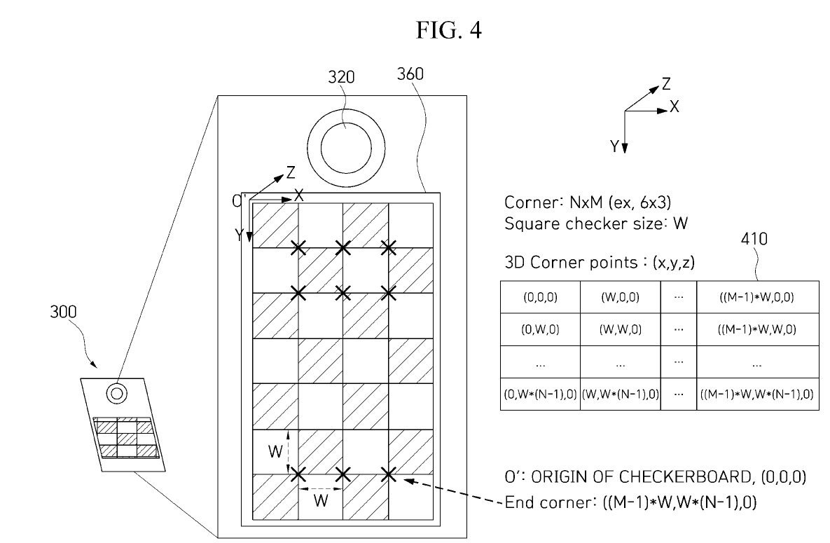

FIG. 4 is a diagram illustrating a method of estimating a relative position of a companion robot on the basis of a specified pattern according to the embodiment. In FIG. 4, the specified pattern board 360 is a checkerboard including a plurality of squares with a width and height of W. However, the specified pattern board 360 is not limited thereto.

Referring to FIG. 4, estimating a relative position of the camera module 250 of the companion robot 200 with respect to the specified pattern on the specified pattern board 360 may be calculated as a perspective-n-point (PnP) problem between 2D feature points on a specified pattern image captured by the camera module 250 and already known 3D reference coordinates based on the design of the specified pattern board 360. Here, the specified pattern includes at least four 3D reference feature points, which corresponds to the technical background in which it is known that n≥4 feature points are required for general PnP problems (e.g., Lepetit et al. “EPnP: An Accurate 0(n) Solution to the PnP Problem,” IJCV, 2009). For example, the controller 280 may estimate a relative position of the companion robot 200 using a solvePnP-related function of open source computer vision library (OpenCV). In the present document, a checkerboard is illustrated as the specified pattern, but any marker or pattern (AprilTag, ArUco, etc.) including at least four 3D reference feature points are also applicable in the same manner.

“X” marks on the specified pattern board 360 may be feature points (n points) of the specified pattern board 360, and when the specified pattern board 360 is viewed from the camera module 250, a direction entering toward the user terminal 300 may be a +Z axis, a direction toward the right may be a +X axis, and a downward direction may be a +Y axis. When the upper-left corner of the specified pattern board 360 is set to (0, 0, 0), 3D coordinate values (3D reference coordinate values) of other corners may be defined as shown in a table 410 on the right in FIG. 4.

After the camera module 250 captures an image of the specified pattern board 360, the companion robot 200 may detect all corner points (feature points) in the captured specified pattern image. The companion robot 200 may calculate 2D coordinate values of the detected corner points on the 2D image and obtain a 3D coordinate triplet (the table 410 on the right in FIG. 4) corresponding to the calculated 2D coordinate values. The companion robot 200 may calculate a relative position (R, t) of the origin point of the camera module 250 with respect to the origin point of the specified pattern board 360 by solving the PnP problem using 2D-3D corresponding coordinates.

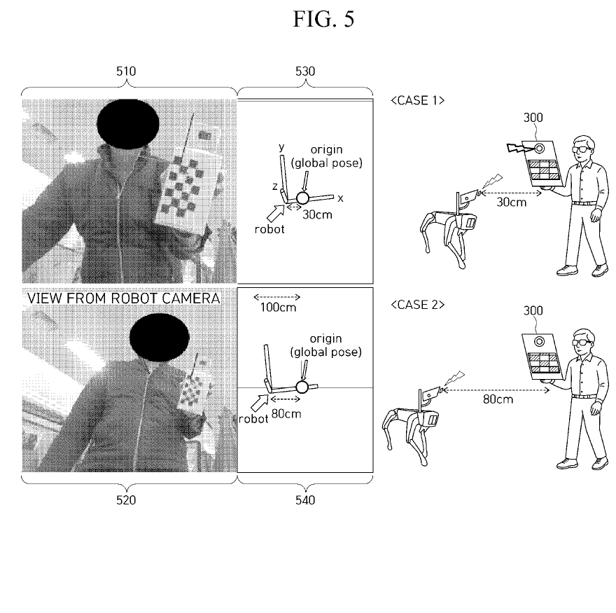

FIG. 5 is a set of views showing a change in the awareness of a relative position depending on distance according to the embodiment.

In FIG. 5, images 510 and 520 on the left show specified pattern images captured by the companion robot 200. As shown in imaging situation illustrations Case 1 and Case 2 on the right, the upper image 510 shows a situation where the companion robot 200 is 30 cm away from the user terminal 300, and the lower image 520 shows a situation where the companion robot 200 is farther, 80 cm away, from the user terminal 300.

As shown in coordinate systems 530 and 540 in the middle, the companion robot 200 may measure changes in relative coordinate values on the basis of the user terminal 300. Therefore, a global position of the companion robot 200 may be obtained by incorporating measured relative position values in a result of recognizing a global position.

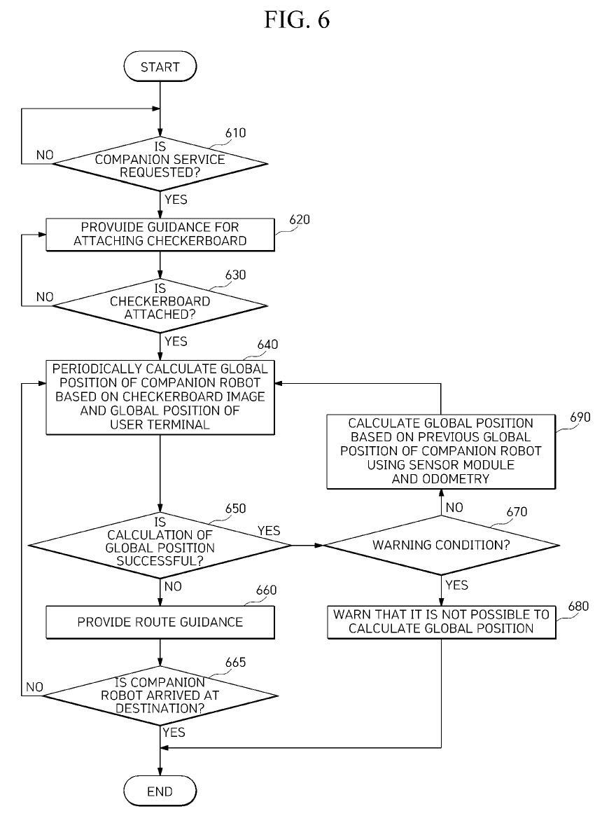

FIG. 6 is a flowchart of a companion guidance service method according to an embodiment.

Referring to FIG. 6, in operation 610, the companion robot 200 may determine that a companion service request has been input by a user. For example, when the user requests the companion service within a specified place through the input device 210, the companion robot 200 may recognize the companion service request input to the input device 210.

In operation 620, the companion robot 200 may provide guidance to install (or attach or mount) the specified pattern board 360 on the back of the user terminal 300.

In operation 630, after providing the guidance for attachment of the specified pattern board 360, the companion robot 200 may determine whether the specified pattern board 360 has been attached to the back of the user terminal 300. For example, the companion robot 200 may capture an image via the camera module 250 to determine whether the specified pattern board 360 has been attached to the back of the user terminal 300 not to cover the camera 320 of the user terminal 300.

When it is determined in operation 630 that the specified pattern board 360 has been attached to the back of the user terminal 300, in operation 640, the companion robot 200 may image the specified pattern board 360 and the user terminal 300. And the companion robot 200 may periodically calculate a global position of the companion robot 200 on the basis of a specified pattern image and global position information of the user terminal 300.

When succeeding in calculating the global position of the companion robot in operation 650, the companion robot 200 may guide the user through a route for which the companion service has been requested, in operation 660.

In operation 665, the companion robot 200 determines whether it has arrived at a destination. When the companion robot 200 has not arrived at the destination, the process may return to operation 640.

When failing to calculate the global position in operation 650, the companion robot 200, in operation 670, may determine whether a warning condition is satisfied. For example, the companion robot 200 may determine whether the current situation corresponds to at least one of the following cases: a case where a global position of the user terminal 300 is not acquired; a case where a threshold period (e.g., 10 seconds) has elapsed since the previous time of calculating the global position; a case where the companion robot 200 has moved a threshold distance; and a case where the companion robot 200 has changed its direction a certain number of times or more. When the current situation corresponds to at least one of the foregoing cases, the companion robot 200 may determine that the warning condition is satisfied.

When it is determined in operation 670 that the warning condition is satisfied, in operation 680, the companion robot 200 may warn through the output device 220 that it is not possible to calculate the global position on the basis of an image.

When it is determined in operation 670 that the warning condition is not satisfied, the companion robot 200 may calculate a current global position of the companion robot 200 on the basis of a previous global position using movement information and odometry of the companion robot 200 based on the sensor module 240 in operation 660.

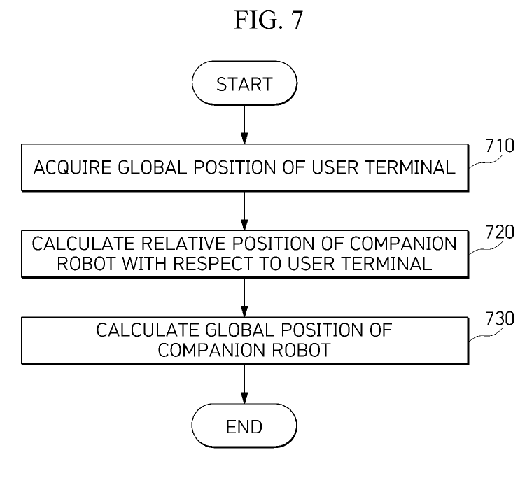

FIG. 7 is a flowchart of a global position calculation method according to an embodiment.

Referring to FIG. 7, in operation 710, the companion robot 200 may acquire global position information (first position information) of the user terminal 300 corresponding to HD map data from the user terminal 300. For example, the companion robot 200 may acquire the global position information of the user terminal 300 from the user terminal 300 via a specified communication channel. In this regard, the user terminal 300 may determine the global position information of the user terminal 300 on the basis of surrounding images captured by the camera 320 through a specified application and transmit the global position information.

In operation 720, the companion robot 200 may calculate a relative position of the companion robot 200 with respect to the user terminal 300 on the basis of a specified pattern image captured through the camera module 250 and at least one sensor of the sensor module 240. For example, as shown in operation 650 of FIG. 6, the companion robot 200 may calculate a relative position of the camera module 250 with respect to the camera 320 of the user terminal 300 on the basis of the correspondence between the specified pattern image and reference coordinates of the specified pattern board 360 using the specified pattern image of the back of the user terminal 300 equipped with the specified pattern board 360. As another example, until moving a specified distance after calculation of the relative position, the companion robot 200 may calculate a relative position of the camera module 250 of the companion robot 200 with respect to the camera 320 of the user terminal 300 on the basis of a location change detected by the sensor module 240.

In operation 730, the companion robot 200 may calculate a global position of the companion robot 200 within the HD map data on the basis of a global position of the user terminal 300 and the relative position.

As described above, the camera module 250 of the companion robot 200 according to the embodiment has a different view angle than a camera used for generating the existing HD map data, but the global position of the companion robot 200 can be corrected on the basis of the specified pattern image and the global position of the user terminal 300. Therefore, it is possible to prevent the performance of image-based positioning from being degraded due to a difference in view angle.

In addition, the companion robot 200 according to the embodiment utilizes a previously built HD map for people, vehicles, etc., without generating new map data for a small robot service, thus leading to a reduction in service implementation costs.

It is to be understood that various embodiments of the present document and terms used in the embodiments are not intended to limit technological features set forth herein to specific embodiments and include various modifications, equivalents, or substitutions for the embodiments. With regard to the description of the drawings, similar reference numerals may be used to refer to similar or related components. A singular form of a noun corresponding to an item may include one or more of the items unless the relevant context clearly indicates otherwise. As used herein, each of phrases such as “A or B,” “at least one of A and B,” “at least one of A or B,” “A, B, or C,” “at least one of A, B, and C,” and “at least one of A, B, or C” may include any one of or all possible combinations of items enumerated together in a corresponding one of the phrases. Terms such as “1st” and “2nd” or “first” and “second” may be used to simply distinguish a corresponding component from another, and do not limit the components in other aspects (e.g., importance or order). When a (e.g., first) component is referred to, with or without the term “functionally” or “communicatively,” as “coupled” or “connected” to another (e.g., second) component, it means that the first component may be coupled to the second component directly (e.g., by wire), wirelessly, or via a third component.

As used herein, the term “module” may include a unit implemented as hardware, software, or firmware, and may be interchangeably used with other terms, for example, “logic,” “logic block,” “part,” or “circuitry.” A module may be a single integral component or a minimum unit or part thereof that performs one or more functions. For example, according to an embodiment, a module may be implemented in the form of an ASIC.

Various embodiments of the present document may be implemented as software (e.g., a program) including one or more instructions stored in a storage medium (e.g., an internal memory or external memory, the first memory 270) that is readable by a machine (e.g., a companion robot). For example, a processor (e.g., the controller 280) of the machine (e.g., the companion robot 200) may invoke at least one of the one or more instructions stored in the storage medium and execute the at least one invoked instruction. This allows the machine to be operated to perform at least one function in accordance with the at least one invoked instruction. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not distinguish between a case where data is semi-permanently stored in the storage medium and a case where data is temporarily stored in the storage medium.

According to an exemplary embodiment, a method according to various embodiments disclosed in the present document may be included and provided in a computer program product. The computer program product may be traded as a product between a seller and a buyer. The computer program product may be distributed in the form of a machine-readable storage medium (e.g., a compact disc (CD)-ROM or distributed (e.g., downloaded or uploaded) online via an application store (e.g., PlayStoreTM) or directly between two user devices (e.g., smartphones). When the computer program product is distributed online, at least a part of the computer program product may be temporarily generated or at least temporarily stored in a machine-readable storage medium, such as memory of the manufacturer’s server, a server of the application store, or a relay server.

Components according to various embodiments of the present document may be implemented in the form of software or hardware such as a digital signal processor (DSP), an FPGA, or an ASIC, and perform certain roles. Components are not limited to software or hardware, and each component may be configured to reside in an addressable storage medium or run on one or more processors. As an example, components may include components such as software components, object-oriented software components, class components, and task components, processes, functions, attributes, procedures, subroutines, segments of program code, drivers, firmware, microcode, circuitry, data, databases, data structures, tables, arrays, and variables.

According to various embodiments, each of the above-described components (e.g., modules or programs) may include a single entity or a plurality of entities. According to various embodiments, one or more of the above-described components or operations may be omitted, or one or more other components or operations may be added. Alternatively or additionally, a plurality of components (e.g., modules or programs) may be integrated into a single component. In this case, the integrated component may still perform one or more functions of each of the plurality of components in the same or similar manner as they are performed by the corresponding one of the plurality of components before the integration. According to various embodiments, operations performed by a module, a program, or another component may be carried out sequentially, in parallel, repeatedly, or heuristically, at least one of the operations may be executed in a different order or omitted, or one or more other operations may be added.

According to various embodiments disclosed in the present document, when a user companion service is provided, positioning can be performed more accurately on the basis of a global position of the user terminal. In addition, various effects that are directly or indirectly found in the present document can be provided.

What is claimed is:

1. A companion robot comprising:
a communication module;
a camera module configured to image surroundings;
a memory configured to store HD mapHD (High Definition) map data of a specified place; and
a controller functionally connected to the camera module and the memory,
wherein the controller acquires global position information of a user terminal, which is determined by the user terminal on the basis of an image captured by another camera provided in the user terminal, corresponding to the map data from the user terminal through the communication module,
generates a specified pattern image by imaging the user terminal equipped with a specified pattern through the camera module, measures a relative position of the camera module with respect to the user terminal on the basis of feature points of the specified pattern image, and
calculates a global position of the companion robot within the map data on the basis of the global position information of the user terminal and the measured relative position.

2. The companion robot of claim 1, wherein a highest altitude of the camera module above ground on which the companion robot is located is less than a reference height for building a map of the map data.

3. The companion robot of claim 2, further comprising an output device,
wherein the controller determines whether an altitude in accordance with the global position of the user terminal is half the reference height or more, and issues a warning to increase an altitude of the user terminal through the output device when the altitude in accordance with the global position is less than half the reference height.

4. The companion robot of claim 1, further comprising:
a docking part of a pattern board on which the specified pattern is formed; and
a sensor module configured to detect whether the pattern board is docked in the docking part,
wherein, when a companion service is requested, the controller determines whether the pattern board is attached to a back of the user terminal using at least one of the sensor module and the camera module and, when the pattern board is attached to a back of the user terminal, calculates the global position of the companion robot on the basis of the global position information and the specified pattern image.

5. The companion robot of claim 1, wherein the camera module includes at least one of a red-green-blue (RGB)-depth (D) camera and a LiDAR system with a view angle for imaging the other camera of the user terminal and the specified pattern.

6. The companion robot of claim 1, wherein the specified pattern is a pattern in which reference coordinate values of at least four three-dimensional (3D) feature points are preset, and
the controller captures an image of the specified pattern using the camera module, extracts two-dimensional (2D) coordinate values of the feature points from the captured image, and calculates the relative position on the basis of correspondences between the reference coordinates stored in the memory and the extracted 2D coordinate values and internal parameters of the camera module.

7. The companion robot of claim 6, wherein the specified pattern is at least one of a checkerboard, a circular grid, an ArUco marker, an AprilTag, and a marker or pattern including the at least four 3D reference feature points.

8. The companion robot of claim 1, wherein the controller calculates the global position of the companion robot additionally on the basis of a relative position of an origin point of the other camera with respect to a reference point of the specified pattern and a relative position of the camera module with respect to a coordinate system of the companion robot.

9. The companion robot of claim 1, wherein, when failing to acquire the relative position on the basis of the specified pattern image, the controller determines whether a warning condition is satisfied, and issues a warning to ensure a view angle for the specified pattern when the warning condition is satisfied.

10. The companion robot of claim 9, wherein the controller determines whether a current situation corresponds to at least one of a case where a threshold period elapses after a previous global position of the companion robot is calculated, a case where the companion robot moves a threshold distance or more, or a case where the companion robot changes its direction a certain number of times or more, and determines that the warning condition is satisfied when the current situation corresponds to at least one of the cases.

11. The companion robot of claim 9, wherein, when the warning condition is not satisfied, the controller calculates the global position of the companion robot using the global position information of the user terminal and at least one of movement information and odometry of the companion robot.

12. A method of calculating a global position by a companion robot which includes a camera module and stores HD map data of a specified place, the method comprising:
acquiring global position information of the user terminal, which is determined by the user terminal on the basis of an image captured by another camera provided in the user terminal, corresponding to the map data from the user terminal;
imaging the user terminal equipped with a specified pattern using the camera module;
measuring a relative position of the camera module on the basis of feature points of a specified pattern image corresponding to the specified pattern; and
calculating a global position of the companion robot within the map data on the basis of the measured relative position and the global position information.

13. The method of claim 12, further comprising:
determining whether an altitude in accordance with the global position of the user terminal is half a reference height for building a map of the map data or more; and
issuing a warning to increase an altitude of the user terminal when the altitude in accordance with the global position is less than half the reference height.

14. The method of claim 12, further comprising:
when a companion service is requested, determining whether a pattern board on which the specified pattern is formed is separated from a docking part and attached to a back of the user terminal; and
after determining that the pattern board is attached to the back of the user terminal, calculating the global position of the companion robot on the basis of the global position information and the specified pattern image.

15. The method of claim 12, wherein the measuring of the relative position of the camera module comprises:
capturing the specified pattern image using the camera module;
extracting two-dimensional (2D) coordinate values of feature points from the specified pattern image; and
calculating the relative position on the basis of correspondences between previously stored three-dimensional (3D) reference coordinate values of actual feature points on the specified pattern and the 2D coordinate values and internal parameters of the camera module.

16. The method of claim 15, wherein the calculating of the relative position comprises calculating the global position of the companion robot additionally on the basis of a relative position of a reference point on the specified pattern with respect to an origin point of the other camera and a relative position of the camera module with respect to a coordinate system of the companion robot.

17. The method of claim 12, wherein the measuring of the relative position of the camera module comprises:
when failing to calculate the relative position on the basis of the specified pattern image, determining whether a warning condition is satisfied; and
when the warning condition is satisfied, issuing a warning to ensure a view angle for the specified pattern.

18. The method of claim 17, wherein the determining of whether the warning condition is satisfied comprises determining whether a current situation corresponds to at least one of a case where a threshold period elapses after a previous global position of the companion robot is calculated, a case where the companion robot moves a threshold distance or more, and a case where the companion robot changes its direction a certain number of times or more, and determining that the warning condition is satisfied when the current situation corresponds to at least one of the cases.

19. The method of claim 17, wherein the measuring of the relative position of the camera module comprises, when the warning condition is not satisfied, calculating a relative position of the companion robot using at least one of movement information and odometry of the companion robot.

20. A user terminal for interacting with a companion robot, the user terminal comprising:
a communication module;
an output device;
a camera configured to image surroundings;
a memory configured to store HD map data of a specified place; and
a processor functionally connected to the camera and the memory,
wherein, when a specified application is executed, the processor requests a companion service for arriving at a destination from a companion robot through the communication module,
captures a surrounding image using the camera, calculates a global position on the basis of the captured image in accordance with the HD map data,
transmits global position information related to the calculated global position to the companion robot, and
provides guidance to raise an altitude of the camera through the output device when an altitude based on the global position is less than a reference altitude related to the HD map data.
